(19) United States
(12) Patent Application Publication
(10) Pub. No.: US 2006/0136403 A1
(43) Pub. Date: Jun. 22, 2006

(54) System and method for digital content searching based on determined intent

(76) Inventor: Charles C. Koo, Palo Alto, CA (US)

Correspondence Address: SQUIRE, SANDERS & DEMPSEY L.L.P, 600 HANSEN WAY, PALO ALTO, CA, 94304-1043, US

(21) Appl. No.: 11/315,410

(22) Filed: Dec. 22, 2005

Related U.S. Application Data
(60) Provisional application No. 60/638,672, filed on Dec. 22, 2004.

(51) Int. Cl. G06F 17/30

(52) U.S. Cl. 707/3

(57) ABSTRACT

A system and method for searching determines an intent of a user based on symptoms entered by the user. The refined query of symptoms and/or intent are forwarded to a search engine to perform a search.

### PRIORITY REFERENCE TO PRIOR APPLICATIONS

This application claims benefit of and incorporates by reference patent application Ser. No. 60/638,672, entitled “Search Navigator—Search by Intent,” filed on Dec. 22, 2004, by inventor Charles C. Koo.

### TECHNICAL FIELD

This invention relates generally to search engines, and more particularly, but not exclusively, provides a system and method for searching based on a determined intent of a user.

### BACKGROUND

In the online search arena, leading search engines, such as Yahoo! Search and Google, typically offer two search vehicles: information search and keyword-match advertising. Unfortunately, the search engines are paralyzed by the millions of documents that match any keywords today. For example, entering the word “cough” generated about 16.5 million matches in December 2005 on Google. An attempt to narrow down search result by entering “cough” and “wheezing” together results in over 800,000 matched documents. The answers that are truly relevant to the user's intent may not necessarily appear in the first several pages, and instead may spread across the entire list of results.

The prevalent approaches for existing search engines to locate the online documents are all based on straightforward keyword matches. The search program visits hundreds of millions of sites and finds documents that exactly match the keywords, and sometime the combinations of them. Some search engines use special search programs called Web “crawlers” to seek all documents that match with popular keywords beforehand and store them for instant responses.

After the engine finds all the documents online that match the keyword(s), the ranking methods created by Google and its variants then approximate the relevance of the document by the popularity of the document in the community. For example, to estimate the popularity of a document, the Page Ranking method created by Google mainly uses the number of hyperlinks from other “trustworthy” websites referring to it. While they provide good approximate rankings of the results from multiple websites, popularity measures do not address the issue that the search user does not know how to narrow down the search criteria in the first place. The problem is compounded by the sheer high number of results. The original promise of search engines that they will alleviate online users from sniffing through volumes of websites is hardly delivered, particularly in complex queries such as medical queries.

The core problem is that users often do not know how to refine a query to obtain relevant answers. Some recent approaches, such as “clustering”, statistically look for other words that often appear along with or near the keyword in the same query, and present these random words to user as guidance/hints for query expansions. As a result, the guidance tends to be a wide range of guesses which may or may not be relevant.

Fundamentally, none of the existing approaches understands what the user's intent is. The search engine will substantially help reduce the results if it knows what the user's true intent is. The key to unlock the power of search in a complex inquiry is to define and formulate user's intent as he/she searches, with the guidance of an expert in the subject matter and to help navigate toward that intent.

### SUMMARY

Embodiments of the invention include a system and method. In one embodiment, the method comprises: determining at least two intents based on a first medical symptom; determining at least one related medical symptom based on the determined at least two intents; and revising the determined at least two intents based on based on a symptom selected by a user from the at least one related medical symptom. Intents can include diseases or health care products (pharmaceuticals, vitamins, over the counter medications, etc.). At any point, a user can cause a search to occur based on the intents and/or symptoms.

In one embodiment, the system comprises a construct knowledgebase and a core. The construct knowledgebase includes symptoms and intents related to the symptoms (e.g., possible diagnoses). The core is capable of determining at least two intents based on a first symptom using the construct knowledgebase; determining at least one related symptom (or “co-existent symptom”) based on the determined at least two intents using the knowledgebase; and revising the determined intents based on a symptom selected by a user from the at least one related symptom using the knowledgebase.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network system in accordance with an embodiment of the invention;

FIG. 2 is a block diagram illustrating a search navigator of the digital content;

FIG. 3 is a block diagram illustrating a persistent memory of the search navigator;

FIG. 4 is a block diagram illustrating an “intent” graph;

FIG. 5 is a flowchart illustrating a method of searching;

FIG. 6 is a screenshot showing search terms (peer concepts) used to refine a search;

FIG. 7 is a screenshot showing possible intents and additional search terms (peer concepts);

FIG. 8 is a screenshot showing a determined intent and additional search terms (peer concepts); and

FIG. 9 is a screenshot showing search results using selected search terms (peer concepts).

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

In an embodiment of the invention, an “Intended Concept” includes is a semantic construct defined by a set of attributes that characterize it. Each attribute is linked with other Intent Concepts via a pair of relations, ITD and DF, which semantically mean “X Intend To Derive Y” and its reverse-relation “Y can be Derived From X”, and, optionally, a score (S) that indicates how strong such a derived intent is. More specifically, the relation reads as follows: “When a user enters the term/concept X, she probably means to find Y, with the strength (sometimes equates the probability) of S.”

Embodiments of the invention pre-construct a set of artificially created constructs (namely “Intended Concepts” with the following basic attributes:

TABLE 1

| | Comments | Example | |
|---|---|---|---|
| Intended Concept | An artificially created conceptual | “Quasi-Asthma” | |
| | object, indicating the intent of a search | | |
| | user | | |
| Concept ID: | A number used to optimize the search | | |
| | with indexes | | |
| Concept Term: | A term/phase/word in a natural | “Asthma” | |
| | language (e.g., English) that possibly | | |
| | resembles this intended concept | | |
| Synonyms: | Possible synonymous terms/ phrases/ | Asthma attack, | |
| | words of the Concept Term | Bronchial asthma | |
| Variances: | Possible variances of the above | Asthma attacking, | |
| | Synonyms (e.g., different major form | asthmatic | |
| | classes) that may appear in the search | | |
| | entry (should be computed | | |
| | automatically) | | |
| DF | A relation with other Intended | Breathing | Feeling tired |
| | Concept. It indicates that this | changes | |
| | Intended-Concept can be Derived | Chest | Want to be |
| | From concept/object listed here. | congestion | alone |
| | These Concepts characterize this | Headache | Get quiet |
| | particular Intended Concept (e.g., | Easily Upset | Feel weak |
| | Quasi-asthma). | Eyes look | Slow down |
| | Notice that a single Concept listed | glassy | |
| | here does not necessarily derive/infer | Dark circles | Feel sad |
| | this Intended Concept. | under eyes | |
| | However, some of them collectively | Get excited | Pale |
| | will indicate an increased probability | Watery eyes | Stuffy nose |
| | of this Intended Concept being the | Sweaty | Restless |
| | searcher's true intent. | Feverish | Grumpy |
| | For each item listed here (e.g., | Chin or | Heart beats |
| | “cough”), there is usually a | throat itches | faster |
| | conditional probability/ score/ | Cough | Sneezing |
| | likelihood indicating its presence if | Change in | Runny nose |
| | this Intended-Concept (e.g., “asthma”) | Sputum | |
| | is already present (e.g., Cough's | (mucus) | |
| | conditional score under Asthma: 0.6). | Dry mouth | Trouble |
| | | | sleeping |
| | | Poor | A downward |
| | | tolerance for | trend in peak |
| | | excerise | flow number |

| | | |
|---|---|---|
| ITD | A relation with other Intended | Flonase nasal |
| | Concept. It indicates that, when a user | inhaler, Serevent |
| | enters this Intended-Concept, he/she | inhaler, etc. (which |
| | “intends to derive” the concept/object | are drugs for |
| | listed here. | Asthma) |
| Is-a | A semantic class that this Intended | “Quasi-Respiratory |
| (or is-a- | Concept belongs to | Disease” |
| type-of) | | |
| Has type: | A semantic sub-class of this Intended | “ . . . Asthma” |
| | Concept | |
| Peer- | A set of other Concepts that point to | “Quasi-COPD”, |
| Concepts: | common Intended Concepts through | etc., which can be |
| | the ITD relation. This can be | treated by Flonase |
| | dynamically constructed. | Nasal Inhaler as |
| | | well |

Each class of Concepts may have its own special attributes in addition
to the above-mentioned basic attributes:

| | | |
|---|---|---|
| Qualifiers: | A set of additional terms that further | In medical areas |
| | qualify the Concepts. | |
| Significant | | Diabetes, |
| medical | | hypertension, etc. |
| considerations | | |
| Age group: | | Infant (0-1) |
| | | Child (2-16), |
| | | adult (16-60), |
| | | senior (60+) |

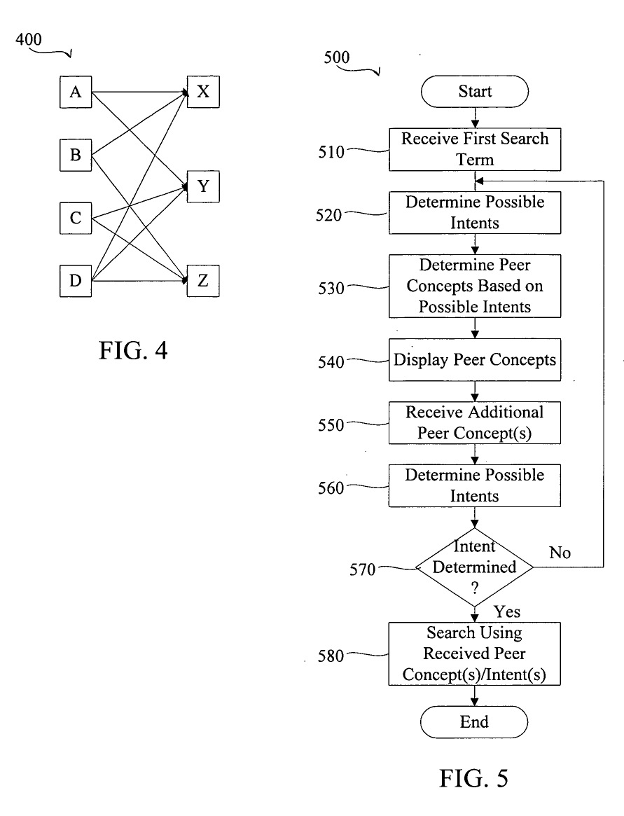

Using a medical query as an example to illustrate the meaning/semantics, the method can be described as the following: When a user enters some symptoms (e.g., “cough”), she may mean to learn what possible diagnosis she has. Embodiments of the invention will form the theory about her possible diagnoses (i.e., the Intended Concept) based on an ITD graph 400 (FIG. 4). In this graph 400, entering a symptom “A” implies that the user intents to derive a diagnosis. Diseases X and Y are the possible Intents in this example.

With the knowledge of possible intents, the embodiments of the invention can provide a meaningful guidance to the search user to refine his/her query. In this example, embodiments can logically use DF relation (inverse of ITD) on the Intended Concept graph 400 to derive all Peer Concepts (B, C, D in this case) and prompt the user with “Do you have the following: B, C, D?”

By adding a new symptom/concept B, the system eliminates Y as a possible intent and refines the query to be “A+B”. In a complex vertical domain, such an expanded or refined query will substantially narrow down the search results by orders of magnitude.

Embodiments of the invention include a system and method that enable the user to refine/expand his/her query using the predefined Intent Graph 400 as the navigation engine. The navigation engine provides the user with domain-specific associated terms/concepts, based on plausible Intents of the user established during a search (rather than based on words statistically collected from other prior queries by the population around the same keyword).

For logical deductions, a conventional deductive system (expert systems, rule-based production systems, etc.) goes through a chaining process that is typically exponential in computation. In contrast, embodiments of the invention are linear in computation as described below.

The process can further illustrated with examples:
Assume that there are only three diseases X, Y, and Z in the entire universe of ants:

In an embodiment of the invention, the world around each ITD relation between two classes of Intended Concepts (e.g., symptom and diseases) in the knowledgebase can be represented as a matrix:

TABLE II

| Symptom/Disease | X | Y | Z |
|---|---|---|---|
| A | * | * | |
| B | * | | * |
| C | | * | * |
| D | * | * | * |

The implied logical deduction can be reformulated as a process (Assume a single fault):
Do Loop until the choice list is empty or when user stops choosing:
When the user selects a symptom S,
1. The system will only consider disease(s) in the row containing S as candidates (and/or eliminate all others do not contain S); and
2. Display for choices all possible symptoms in all columns containing S. (Avoid redundant displays)

Going back to the example:
Scenario 1:
Step 1: when the user selects a symptom A,
1. The system will only consider X, Y by looking up the row containing A (and eliminate Z); and
2. Display B, C, D for choices by looking at all columns containing A.
Step 2: when the user selects a symptom B,
1. The system will only consider X, by looking up the row containing A (and eliminate Y); and
2. Display D for choices by looking at all columns containing B.
Step 3: when the user selects a symptom D,
1. The system will only consider X, by looking up the row containing A (and eliminate Y); and
2. Display nothing for choices by looking at all columns containing D.
Process terminates.
Scenario 2:
Step 1: when the user selects a symptom A,
1. The system will only consider X, Y by looking up the row containing A (and eliminate Z); and
2. Display B, C, D for choices by looking at all columns containing A.
Step 2: when the user selects a symptom D,
1. The system will still only consider X, Y, by looking up the row containing A (and eliminate nothing); and
2. Display B, C for choices by looking at all columns containing D.
Step 3: when the user selects a symptom B,
1. The system will only consider X, by looking up the row containing A (and eliminate Y); and
2. Display nothing for choices by looking at all columns containing B.
Process terminates.

In any of the earlier steps, the user may stop selecting any additional choices. The process terminates then.

This process guarantees to terminate quickly and with a great performance/user response time. Even in a complex search domain such as medical diagnosis, the number of symptoms (or Original Observation Concept) is finite (limited to 800+− symptoms in the human world), and the number of possible diagnoses (or Possible Intended-Concept) is also finite (limited to 6000 diseases).

Per each symptom, possible diagnoses are estimated to be less than a few hundred. In addition, there are only 10 to 50 “Peer Concepts” (or associated symptoms) per symptom. Thus, it makes sense to cache all the possible associated symptoms per each symptom for fast user experience.

When more than two symptoms are selected, the number of possible diagnoses is substantially reduced. Thus, embodiments of the invention only need to cache the Peer-Concepts at the first step/tier and obtain the Peer Concepts dynamically from the second step down.

Performance Analysis: By caching the first-tier Peer Concepts, the size of the matrix that needs to be transmitted to the user's computer may be drastically reduced from 4,800,000 (6000*800) to 380 (300 possible diseases per symptom+80 associated symptoms). When the user selects the second symptom, embodiments of the invention will transmit it (a few bytes of data) to the server, and obtain the Peer Concept dynamically. The server will send the Peer Concepts back to the user-end computer for display. (Note, this will be a small subset of the initial Peer-set.) As such, a minimum standard for user response time can be established. If found that the first-tier caching is not enough, then caching can occur at the second level, e.g., the peer-concepts per PAIR of symptoms.

With the help of Intent formation and the traversal of the ITD graph, embodiment of the invention will rapidly help the user optimally refine his/her query for a pin-pointing search. This will allow the user to maximally expand the original query in a single pass of interaction. It avoids the long-winded multiple-passes of Q&A interactions in knowledge-based expert system and optimizes the performance of the embodiments of the invention.

Embodiments transforms an exponential deductive process (O(mⁿ)) into a substantially less complex (O(m*n)) computing process, where m, n are the numbers of originating and intended concepts respectively. Furthermore, with the cached Peer-Concept relation per originating Concept (e.g., the symptom), the complexity is reduced to a linear process (O(m+n)). Such a technique using of pre-processed “peer-concepts” minimizes the response time of this query expansion process.

In an embodiment, an algorithm computes and derives the “Relevance Strength” of each possible Intent, which measures the strength of each possible user intent based on the entered words in the query and their individual pre-existent Conditional Strength per individual intent. In one embodiment, a version of Bayesian Networks is applied and conditional probability in computing the relevance to user's intent.

In an embodiment, a systematic method approximates the Conditional Strength and an algorithm in a search process, using the result counts in online search. This method avoids the massive and extremely expensive effort of establishing the Conditional Relevance Strength in prior arts. To establish the Conditional Relevance Strength, or prior probability in Bayesian Networks, all prior methods require statistic sampling in an adequate sample space for each and every concept. In the real world, the number of “concepts” may be in the hundreds of thousands. (E.g., there are over 6,000 possible diseases, which can be further separated into 50,000 possible ICD-9 disease codes, each of which will take a long time to obtain its conditional probabilities of its symptoms.)

The invention will now be described in relation to the figures.

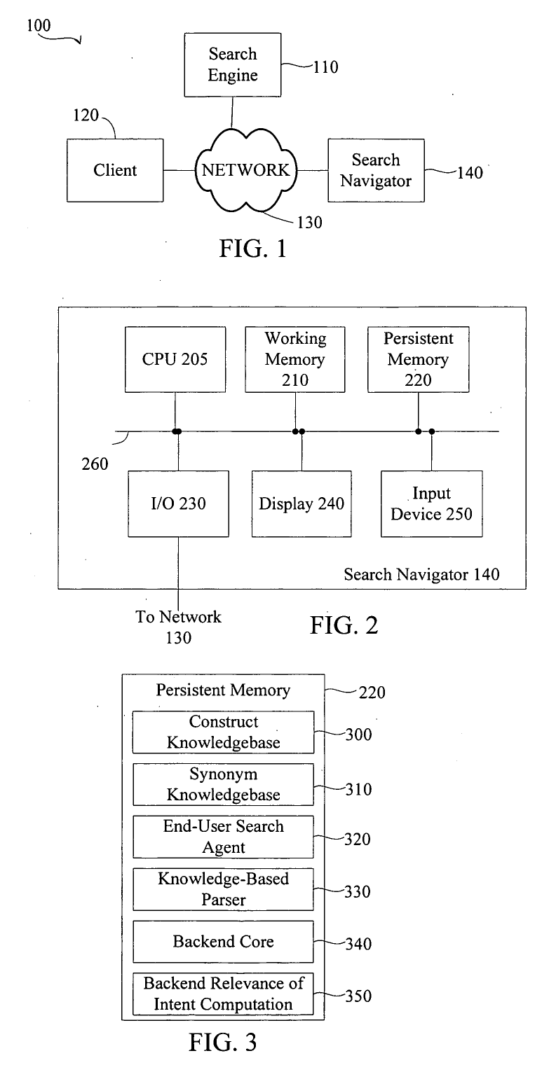

FIG. 1 is a block diagram illustrating a network system 100 in accordance with an embodiment of the invention. The network system 100 includes a search engine 110, a client 120, a network 130, and a search navigator 140. The search engine 110, the client 120, and the search navigator 140 are each coupled to the network 130, such as the Internet, to enable communication between network nodes. In an embodiment of the invention, the search engine 110 includes Google, Yahoo!, and/or other search engine.

The search navigator 140, as will be discussed further below, determines possible intents based on a search term and provides additional search terms for selection by the user related to the possible intents. For example, for a search term cough, a possible intent would be asthma. Accordingly, the search navigator 240 would determine what other search terms would yield a result of asthma and provide those terms to the user for selection. If there are other intents related to the search term, then the related search terms can also be displayed for selection by the user to narrow down the possible intents. At any point, the user can then search based on the search terms and/or intents by having the search navigator 140 transmit the search terms and/or intents to the search engine 110.

FIG. 2 is a block diagram illustrating the search navigator 140 of the network system 100. The search navigator 140 includes a central processing unit (CPU) 205; working memory 210; persistent memory 220; input/output (I/O) interface 230; display 240; and input device 250, all communicatively coupled to each other via a bus 260. The CPU 205 may include an INTEL PENTIUM microprocessor, a Motorola POWERPC microprocessor, or any other processor capable to execute software stored in the persistent memory 220. The working memory 210 may include random access memory (RAM) or any other type of read/write memory devices or combination of memory devices. The persistent memory 220 may include a hard drive, read only memory (ROM) or any other type of memory device or combination of memory devices that can retain data after the search navigator 140 is shut off. The I/O interface 230 is communicatively coupled, via wired or wireless techniques, to the network 130. The display 240 may include a flat panel display, cathode ray tube display, or any other display device. The input device 250, which is optional like other components of the invention, may include a keyboard, mouse, or other device for inputting data, or a combination of devices for inputting data.

In an embodiment of the invention, the search navigator 140 may also include additional devices, such as network connections, additional memory, additional processors, LANs, input/output lines for transferring information across a hardware channel, the Internet or an intranet, etc. One skilled in the art will also recognize that the programs and data may be received by and stored in the search navigator 140 in alternative ways. Further, in an embodiment of the invention, an ASIC is used in placed of the search navigator 140.

FIG. 3 is a block diagram illustrating the persistent memory 220 of the search navigator 140. The persistent memory 220 includes a construct knowledgebase 300; a synonym knowledgebase 310; an end-user search agent 320; a knowledge-based parser 330; a backend core; and a backend relevance of intent computation engine 350. Details are included in Table III, below.

TABLE III
Construct Knowledgebase
Knowledge structure/construct
Characteristic mapping (Attributes, taxonomy). For example:
Concepts: cough
Is-a: symptom
ITD: allergy, asthma, COPD, bronchitis
Concepts: allergy
Is-a: disease
DF: cough, wheezing, shortness-of-breath
ITD: Claritin
Concepts: Claritin
Is-a: OTC medicine
DF: allergy, allergic rhinitis, etc.
Synonym knowledgebase (For example:
“Shortness of breath” is-a-synonym-of “breathlessness” (strength = 1.0,
which means they mean exactly the same.)
“Hard to breath” is-a-synonym-of “breathlessness” (strength = 0.8)
End-user search agent (A program)
UI (auto display of peer terms)
UI (auto contraction by sets)
UI (auto expansion for multiple intents/threads)
UI (auto display of possible diseases)
interface with the “relevance” count
Knowledge-based Parser (A program)
map entered words to controlled words
map controlled words to Concept Constructs based on the synonym
knowledge base
Backend Core
The Intent graph (dynamically constructed)
Connect possible intents (Diagnosis CC)
Calculate “Relevance Score” of each intent
Relevance Score Calculation module
Compute score based on Bayesian network
Pre-compute scores based on Bayesian network
Cache and index all possible scores
Backend “relevance” of intent computation
Bayesian Prior from the counts
Bayesian Posterior

FIG. 4 is a block diagram illustrating an intent graph 400. The graph indicates search terms A, B, C, D and related intents X, Y, and Z. A intends-to-derive (ITD) X or Y; B ITD X or Z; C ITD Y or Z; and D ITD X or Z. The search navigator 140 can then determine peer concepts (search terms) associated with X and Y and display them (e.g., A, B, C, and D). The user's subsequent selection of a peer concept will narrow down the possible intents. For example, the selection of B ITD the intent of X only and the elimination of Y. In an embodiment of the invention, it is possible to have two intents simultaneously (e.g., a person could have symptoms of two different diseases indicating that he/she has two different diseases). In an embodiment of the invention, the intent for symptoms can also be a treatment or over-the-counter medicine for the symptoms, e.g., for the symptom headache, the intent is aspirin.

The “derived from” (DF) relations allow the user to select an intent and conversely narrows the selectable choices of the search terms for the user. The combination and iteration of ITDs and DFs substantially reduce the computation and formulate a refined query, and thus search results rapidly.

FIG. 5 is a flowchart illustrating a method 500 of searching. In an embodiment of the invention, the search navigator 140 and the search engine 110 perform the method 500. In an embodiment of the invention, the navigator 140 and engine 110 can perform multiple instantiations of the method substantially simultaneously. First, a search term (e.g., symptom) is received (510). Possible intents (disease diagnosis) are then determined (520). Then possible search terms are determined (530) and displayed (540) based on possible intents. A user then selects one or more additional search terms, which are received (550) and possible intents are then determined (560). Due to the receipt of additional search terms, the intent may be determined as discussed above in conjunction with FIG. 4. If the intent is (570) determined or there are no more search terms, then a search is performed (580) based on intent(s) and/or search term(s) selected by the user and received. In an embodiment, the method 500 can include transmitting the search term(s) and/or intent(s) to a search engine to perform the search instead of the performing (580). The method 500 then ends. Otherwise, the method 500 repeats from (520). In an embodiment of the invention, the method 500 can be halted at any point and the search performed (580) using any received search term(s) and/or intent(s).

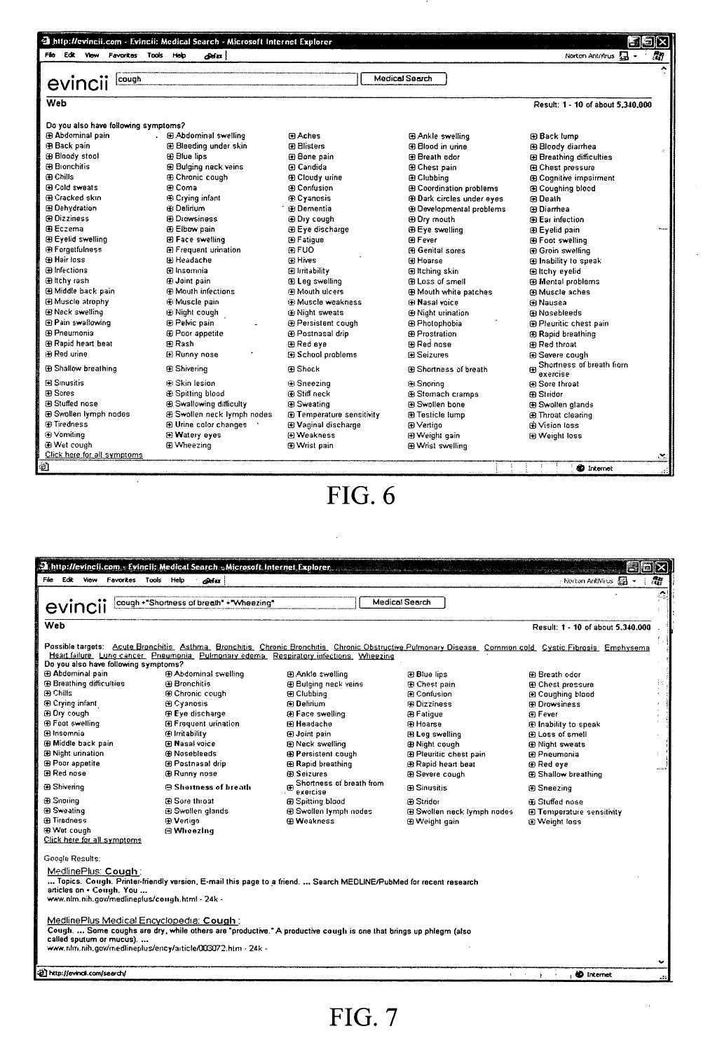

FIG. 6 is a screenshot showing search terms (peer concepts) used to refine a search (assuming the first term or symptom was cough). As the user enters the same word “cough”, the system instantly comes up with a comprehensive list of possible Peer-Terms (or co-existent symptoms) for user to choose from. Such a list is NOT randomly collected from the popular list of nearby terms, but from the professional-knowledge base.

FIG. 7 is a screenshot showing possible intents and additional search terms (peer concepts). The user selects other symptoms (peer concepts) in his/her mind, say “shortness of breath” and “wheezing”, the system will instantly narrow down the possible “INTENTS” (i.e., the possible diagnoses in this example) and automatically narrows the choice list.

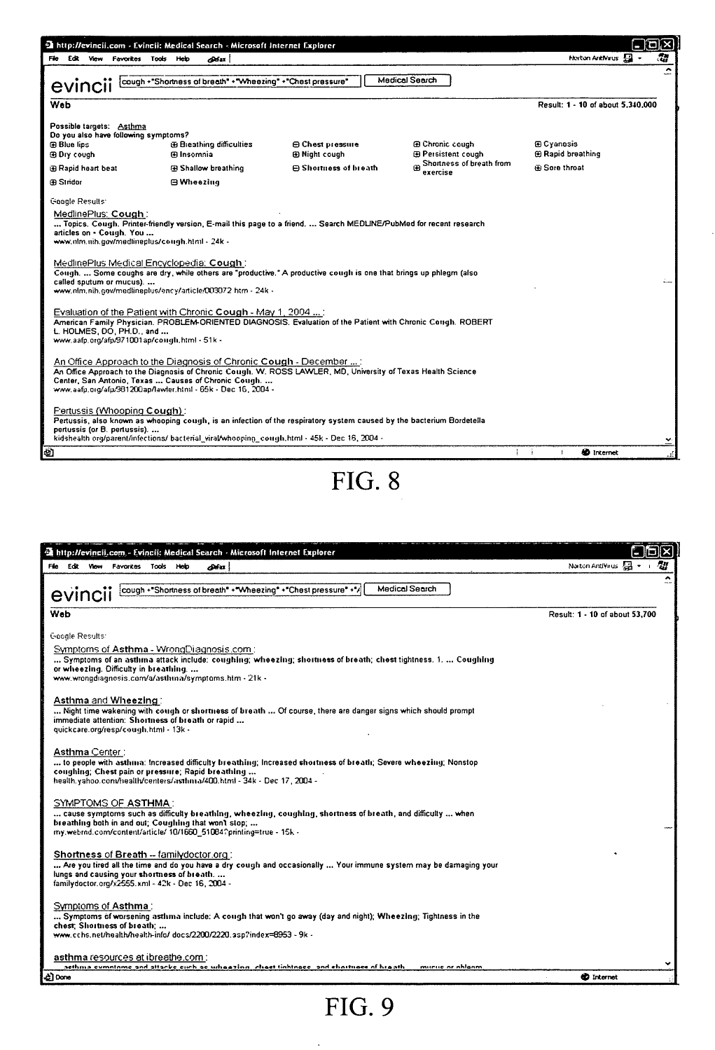

FIG. 8 is a screenshot showing a determined intent and additional search terms (peer concepts). If the user selects additional Peer-term(s), the possible intents eventually will narrow to a single one.

FIG. 9 is a screenshot showing search results using selected search terms (peer concepts). The user can stop selection at any time and start the online search; or she can include a certain likely intent (e.g., “Asthma”). As soon as the user selects all his/her Peer-terms/symptoms, the system maximally expands the query.

When the user press “SEARCH”, the newly expanded expression of words is used to perform the query. The number of returned results is substantially reduced to 53,000, which is a 100-times reduction. Most importantly, the relevant results will almost always show up within the first 10-15 results (i.e., the first page in most search engines).

The foregoing description of the illustrated embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. For example, the search navigator 140 and the search engine 110 can be combined with the client 120. Also, the client 120, also referred to as a computer, can include device capable of computing, such as a personal digital assistant, wireless phone, laptop or desktop computer. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A computer-based method, comprising:
determining at least two intents based on a first medical symptom;
determining at least one related medical symptom based on the determined at least two intents; and
revising the determined at least two intents based on a symptom selected by a user from the at least one related medical symptom.

2. The method of claim 1, further comprising transmitting the revised intents to a client for display.

3. The method of claim 1, further comprising performing a search based on the first symptom and the at least one related symptom.

4. The method of claim 3, wherein the performing further includes performing the search based on the revised intents.

5. The method of claim 1, wherein the determining at least two intents based on a first symptom is further based on a relevance strength of the first symptom.

6. The method of claim 1, further comprising repeating the determining at least one related symptom and the revising.

7. The method of claim 1, wherein the determining at least two intents is further based on synonyms of the first symptom.

8. The method of claim 1, wherein the determining at least two intents based on a first symptom is further based on a conditional strength of the first symptom.

9. The method of claim 1, wherein the at least two intents includes a disease.

10. The method of claim 1, wherein the at least two intents includes a health product.

11. A system, comprising:
a construct knowledgebase of symptoms and intents related to the symptoms; and
a core capable of
determining at least two intents based on a first symptom using the construct knowledgebase;
determining at least one related symptom based on the determined at least two intents using the knowledgebase; and
revising the determined at least two intents based on based on a symptom selected by a user from the at least one related symptom using the knowledgebase.

12. The system of claim 11, further comprising an end-user search agent capable of transmitting the revised intents to a client for display.

13. The system of claim 11, further comprising an end-user search agent capable of transmitting the first symptom and the at least one related symptom to a search engine for searching.

14. The system of claim 13, wherein the end-user search agent is further capable of transmitting the revised intents to a search engine for searching.

15. The system of claim 11, further comprising a backend relevance of intent computation engine and wherein the determining at least two intents based on a first symptom is further based on a relevance strength of the first symptom calculated by the relevance of intention computation engine.

16. The system of claim 11, wherein the core is further capable of repeating the determining at least one related symptom and the revising.

17. The system of claim 11, further comprising a synonym knowledgebase and wherein core determines the at least two intents further based on synonyms of the first symptom using the synonym knowledgebase.

18. The system of claim 11, further comprising a backend relevance of intention computation engine and wherein the determining at least two intents based on a first symptom is further based on a conditional strength of the first symptom calculated by the relevance of intention computation engine.

19. The system of claim 11, wherein the at least two intents includes a diagnosis.

20. The method of claim 11, wherein the at least two intents includes a health product.

21. The method of claim 11, wherein the core is further capable of determining conversely at least one related symptom based on an intent selected by a user from the at least two intents.

22. A computer-readable medium having stored thereon instructions to cause a computer to execute a method, the method comprising:
determining at least two intents based on a first symptom;
determining at least one related symptom based on the determined at least two intents; and
revising the determined at least two intents based on based on a symptom selected by a user from the at least one related symptom.

23. A system, comprising:
means for determining at least two intents based on a first symptom;
means for determining at least one related symptom based on the determined at least two intents; and
means for revising the determined at least two intents based on based on a symptom selected by a user from the at least one related symptom.
